(19) United States
(12) Patent Application Publication
(10) Pub. No.: US 2020/0258078 A1
(43) Pub. Date: Aug. 13, 2020

(54) SYSTEMS, METHODS AND COMPUTER PROGRAM PRODUCTS FOR WALLET PAYMENT TRANSACTIONS

(71) Applicant: Mastercard International Incorporated, Purchase, NY (US)

(72) Inventors: Kaustubh Kishor Bagul, Nashik (IN); Prasenjit Bhattacharjee, Pune (IN); Akshay Varma, Kalyan (IN); Sonal Vishwas Khanvilkar, Pune (IN); Khushboo Singhal, Kota (IN)

(73) Assignee: Mastercard International Incorporated, Purchase, NY (US)

(21) Appl. No.: 16/784,521

(22) Filed: Feb. 7, 2020

(30) Foreign Application Priority Data
Feb. 7, 2019 (IN) 201911004931

(51) Int. Cl. G06Q 20/36; G06Q 20/22; G06Q 20/08

(52) U.S. Cl. CPC G06Q 20/3676; G06Q 20/085; G06Q 20/227

(57) ABSTRACT

The invention comprises systems, methods and computer program products for implementing a payment wallet based electronic payment transaction. The invention comprises (i) receiving from a wallet application a payment amount, a payment wallet account associated with a payor, and a payee account, (ii) identifying a plurality of payment accounts associated with the identified payment wallet account, (iii) for each identified payment account, retrieving from a corresponding issuer server, information identifying available funds in said payment account, (iv) transmitting account information corresponding to one or more of the identified payment accounts to the client terminal, (v) receiving from the client terminal, input identifying a selected payment account from among the identified payment accounts, and (vi) transmitting to an issuer network associated with the selected payment account, a payment initiation request for effecting payment of the payment amount from the selected payment account to the payee account.

### CROSS REFERENCE TO RELATED APPLICATIONS

This application claims priority to Indian Application Serial No. 201911004931, filed Feb. 7, 2019, which is incorporated herein by reference in its entirety

### FIELD OF THE INVENTION

The present invention relates to the field of electronic payment transactions, and more specifically to systems, methods and computer program products for implementing electronic payment transactions through a payment wallet.

### BACKGROUND OF THE INVENTION

Electronic transactions and payments using payment cards or electronic payment accounts are increasingly common—with the number of electronic payment transactions and ubiquity of electronic transaction mechanisms and services growing steadily.

The use of electronic payment transactions for effecting payment for goods or services through network communication based software wallets is particularly popular.

FIG. 1 illustrates a prior art system environment 100 that is configurable to implement prior art methods of wallet based electronic payment. Client terminal 102 may comprise any network communication enabled data processing terminal having payment wallet application software implemented therein. Client terminal 102 may in the illustrated system environment comprise a computer system 102a or a mobile communication device 102b or any other processor implemented data processing device having network communication capabilities and that is configured to implement functionality of payment wallet application software that has been installed thereon.

Client terminal 102 may be communicably coupled with merchant server 106 through communication network 104—and merchant server 106 may be configured to communicate with client terminal 102 for enabling initiation of a payment transaction (for goods or services acquired through merchant server 106) through payment wallet application software installed on client terminal 102. For the purposes of initiating the payment transaction, merchant server 106 may be configured to transmit to client terminal 102, a payment transaction amount along with information identifying a merchant payment account to which transaction payment requires to be credited.

Upon receipt of the payment transaction amount and information identifying a merchant payment account to which payment requires to be credited, a payment wallet implemented within client terminal 102 may be configured to initiate payment of the transaction amount from a payment account, payment card or other payment vehicle registered or onboarded with the payment wallet. Responsive to initiation of the payment from the payment wallet, an issuer network 110 associated with the payment account, payment card or payment vehicle that is being used for making the payment is instructed to transfer the transaction amount from the payment account, payment card or payment vehicle to the merchant payment account which is maintained within issuer network 108.

One or both of acquirer network 108 and issuer network 110 may in certain embodiments be configured in the form of the exemplary network 200 illustrated in FIG. 2—comprising a network server 202, network database 204 and interface gateway 206.

In a specific embodiment, where network 200 is implemented within acquirer network 108, network server 202 may be configured to receive and process information relating to payment card, payment account or payment vehicle transactions. In an embodiment, network server 202 may receive or process transactions concerning accounts maintained with the acquirer—which determination may be made based on information retrieved from the acquirer network database 204. Interface gateway 206 may include a hardware or software network gateway configured to enable the acquirer network 108 to communicate with network 104 and/or merchant server 106.

In an embodiment where network 200 is implemented within issuer network 110, network server 202 may be configured to receive and process information relating to electronic payment transactions. In an embodiment, the network server 202 may receive or process transactions concerning accounts maintained with the issuer—which determination may be made based on information retrieved from the issuer network database 204. Interface gateway 206 may include a hardware or software network gateway configured to enable the issuer network 110 to communicate with network 104 and/or client terminal 102.

It has been found that when using a payment wallet for the purposes of implementing a payment transaction, the payor often does not have information regarding available balance associated with a payment account, payment card or other payment vehicle that is being selected at the payment wallet for the purpose of implementing a payment transaction. As a result, in the event that a transaction amount is greater than the available balance or available liquid funds associated with a selected payment account, payment card or payment vehicle, the issuer network may reject the payment request for lack of sufficient funds, or may allow the transaction and apply overdraft charges or penalties to the payor. Rejection of a transaction, and applied overdraft charges/penalties, are responsible for poor user experiences, which restrict or retard further adoption of wallet based payment transaction mechanisms.

There is accordingly a requirement for a solution that enables implementation of payment transactions through a payment wallet, while simultaneously ensuring that a payment request initiated in connection with a payment account, payment card or payment vehicle linked to a payment wallet does not exceed the available funds associated with such account, card or vehicle.

### SUMMARY

The invention provides systems, methods and computer program products for implementing electronic payment transactions through an electronic wallet. Specifically, the invention enables initiation of electronic payment of a payment amount through a payment wallet, subject to prior confirmation of sufficiency of available funds or liquid funds within a payment account selected for payment through said payment wallet.

In one embodiment, the invention comprises a system for implementing a payment wallet based electronic payment transaction. The system may comprise a processor implemented wallet server configured to (a) receive from a wallet application installed on a client terminal, (i) a payment amount, (ii) a payment wallet account associated with a payor and (iii) a payee account, (b) identify a plurality of payment accounts associated with the identified payment wallet account, (c) for each identified payment account, retrieve from a corresponding issuer server, information identifying available funds in said payment account, (d) transmit account information corresponding to one or more of the identified payment accounts to the client terminal, (e) receive from the client terminal, input identifying a selected payment account from among the identified payment accounts and (f) transmit to an issuer network associated with the selected payment account, a payment initiation request for effecting payment of the payment amount from the selected payment account to the payee account.

In a system embodiment, the wallet server may be configured such that, for each of the plurality of payment accounts associated with the identified payment wallet account, the wallet server has been allowed permission to access from each corresponding issuer network, available balance information corresponding to the payment account.

The wallet server may additionally be configured to retrieve for each identified payment account, information identifying a minimum balance requirement associated with said payment account.

In a particular embodiment, the wallet server is configured such that the transmitted account information corresponding to one or more of the identified payment accounts comprises at least an account number and information representing available funds corresponding to said one or more of the identified payment accounts.

At least one or the wallet server and the client terminal may be configured to enable the client terminal to display a selected subset of said one or more of the identified payment accounts, wherein (i) each of the payment accounts within the selected subset has available funds greater than the payment amount, or (ii) for each of the payment accounts within the selected subset, a difference between the available funds and a required minimum balance associated with such payment account is greater than the payment amount.

In a system embodiment, the selected payment account is selected from among the selected subset. The selected payment account may be selected from among the select subset based on user input received at the client terminal.

The issuer network may be configured to respond to receiving the payment initiation request by debiting the payment amount from the selected payment account and crediting the payment amount to the payee account.

The invention additionally provides a method for implementing a payment wallet based electronic payment transaction. The method comprises, at a wallet server (a) receiving from a wallet application installed on a client terminal, (i) a payment amount, (ii) a payment wallet account associated with a payor and (iii) a payee account, (b) identifying a plurality of payment accounts associated with the identified payment wallet account, (c) for each identified payment account, retrieving from a corresponding issuer server, information identifying available funds in said payment account, (d) transmitting account information corresponding to one or more of the identified payment accounts to the client terminal, (e) receiving from the client terminal, input identifying a selected payment account from among the identified payment accounts, and (f) transmitting to an issuer network associated with the selected payment account, a payment initiation request for effecting payment of the payment amount from the selected payment account to the payee account.

In a method embodiment, for each of the plurality of payment accounts associated with the identified payment wallet account, the wallet server has been allowed permission to access from each corresponding issuer network, available balance information corresponding to the payment account.

The method may include additionally retrieving for each identified payment account, information identifying a minimum balance requirement associated with said payment account.

In an embodiment of the method, the transmitted account information corresponding to one or more of the identified payment accounts comprises at least an account number and information representing available funds corresponding to said one or more of the identified payment accounts.

The method may comprise displaying at the client terminal a selected subset of said one or more of the identified payment accounts, wherein (i) each of the payment accounts within the selected subset has available funds greater than the payment amount, or (ii) for each of the payment accounts within the selected subset, a difference between the available funds and a required minimum balance associated with such payment account is greater than the payment amount.

In a specific method embodiment, the selected payment account is selected from among the selected subset. The selected payment account may be selected from among the select subset based on user input received at the client terminal.

In one method embodiment, the issuer network responds to receiving the payment initiation request by debiting the payment amount from the selected payment account and crediting the payment amount to the payee account.

The invention further provides, a computer program product configured for implementing a payment wallet based electronic payment transaction, the computer program product comprising a non-transitory computer readable medium having a computer readable program code embodiment therein, said computer readable program code comprising instructions for implementing at a wallet server, (a) receiving from a wallet application installed on a client terminal, (i) a payment amount, (ii) a payment wallet account associated with a payor and (iii) a payee account, (b) identifying a plurality of payment accounts associated with the identified payment wallet account, (c) for each identified payment account, retrieving from a corresponding issuer server, information identifying available funds in said payment account, (d) transmitting account information corresponding to one or more of the identified payment accounts to the client terminal, (e) receiving from the client terminal, input identifying a selected payment account from among the identified payment accounts, and (f) transmitting to an issuer network associated with the selected payment account, a payment initiation request for effecting payment of the payment amount from the selected payment account to the payee account.

The invention additionally provides computer program products for initiation of electronic payment of a payment amount through a payment wallet, comprising a non-transitory computer usable medium having computer readable program code embodied therein, the computer readable program code comprising instructions for implementing any of the more specific method embodiments described in the disclosure herein.

### BRIEF DESCRIPTION OF THE ACCOMPANYING DRAWINGS

FIG. 1 illustrates a prior art system environment for implementing payment wallet based electronic transactions.

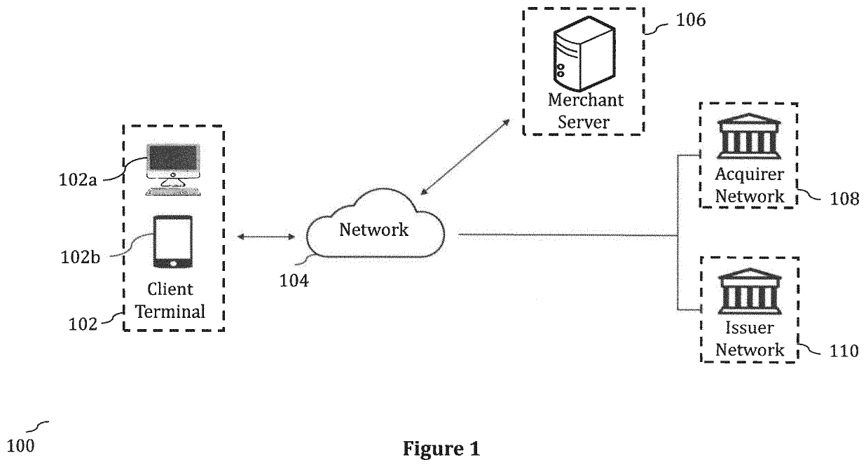

FIG. 2 illustrates a system environment that has been configured for authenticating and implementing electronic transactions through a payment account, payment card, or payment vehicle based transaction system in accordance with the present invention.

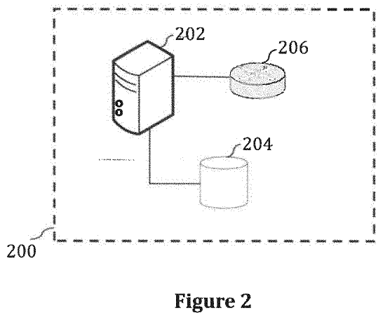

FIG. 3 illustrates components of a system environment that is configured for implementing an embodiment of the invention.

FIG. 4 is a flowchart illustrating a method implemented at a wallet server for obtaining permission for a payment wallet to receive available fund information corresponding to one or more payment accounts enrolled with said payment wallet, as implemented at a wallet server.

FIG. 5A is a flowchart illustrating a method implemented at an issuer server for obtaining permissions for a payment wallet to receive available fund information corresponding to one or more payment accounts enrolled with said payment wallet.

FIG. 5B is an exemplary data structure of a type that may be used for generating either wallet server data records or issuer server data records of a kind that are discussed in connection with FIGS. 4 and 5A.

FIG. 6 is a communication flow diagram illustrating a method for a wallet server to obtain permission to access available fund information corresponding to a payment account linked to a payment wallet account.

FIG. 7 is a flowchart illustrating a method for effecting an electronic payment in accordance with the present invention.

FIG. 8 is a communication flow diagram illustrating a method for effecting an electronic payment in accordance with the present invention.

FIG. 9 illustrates an exemplary computer system according to which various embodiments of the present invention may be implemented.

### DETAILED DESCRIPTION

The invention provides systems, methods and computer program products for implementing electronic payment transactions through an electronic wallet. Specifically, the invention enables initiation of electronic payment of a payment amount through a payment wallet, based on prior confirmation of fund sufficiency within a payment account selected for payment through said payment wallet.

For the purposes of the present invention, the following terms shall be understood to have the corresponding meanings provided below:

“Acquirer” shall mean a business (e.g., a financial institution or a merchant bank) that contracts with a merchant to coordinate with the issuer network of a customers' payment card or payment account.

“Card holder”, “Account Holder” or “Customer” shall mean an authorized user of a payment card or payment account who is making a purchase or effecting an electronic transaction with a payment card or payment account.

“Issuer” shall mean a financial institution that issues payment cards or payment accounts and maintains a contract with a customer or card holder or account holder for repayment or settlement of purchases made on the payment card.

“Issuer network” shall refer to a communication network, including hardware, software and other equipment used by an issuer to transmit and process payment card transactions and information related to customers, payment cards and transactions.

“Merchant” shall mean an authorized acceptor of payment cards or of payment account information for the payment of goods or services sold by the merchant.

“Payment account” shall mean any account that may be used for the purposes of effecting an electronic payment or electronic transaction, and shall include any electronic transaction account, payment card account, bank account or electronic wallet account.

“Payment card” or “Payment Vehicle” shall mean a card or data or any other instrument associated with a payment account that may be provided to a merchant in order to fund a financial transaction via the associated payment account. Payment cards or payment vehicles may include credit cards, debit cards, charge cards, stored-value cards, prepaid cards, fleet cards, virtual payment numbers, virtual card numbers, controlled payment numbers, etc. A payment card or payment vehicle may be a physical card that may be provided to a merchant, or may be data representing the associated payment account (e.g., as stored in a communication device, such as a smart phone or computer). For example, in some instances, data including a payment account number may be considered a payment card or payment vehicle for the processing of a transaction funded by the associated payment account. In some instances, a check may be considered a payment card where applicable.

“Payment network” shall refer to the intermediary between the merchant's acquirer and the customer's issuer (for example, Mastercard® or Visa®). The payment network primarily coordinates payment card or payment account transactions between acquirers and issuers, and additionally coordinates clearing and settlement services to transfer payments from issuers to merchants.

“Payment wallet” or “Payment wallet application software” shall refer to application software or processor readable program code configured to provide functionality for viewing and selecting bills to be paid or payments to make, viewing and selecting payment sources, payment cards, payment accounts or payment vehicles that may be used for the purposes of effecting an electronic payment transaction, viewing available balance(s) associate with said payment sources, payment cards, payment accounts or payment vehicles, and/or initiating a payment transaction from a payor account to a payee account.

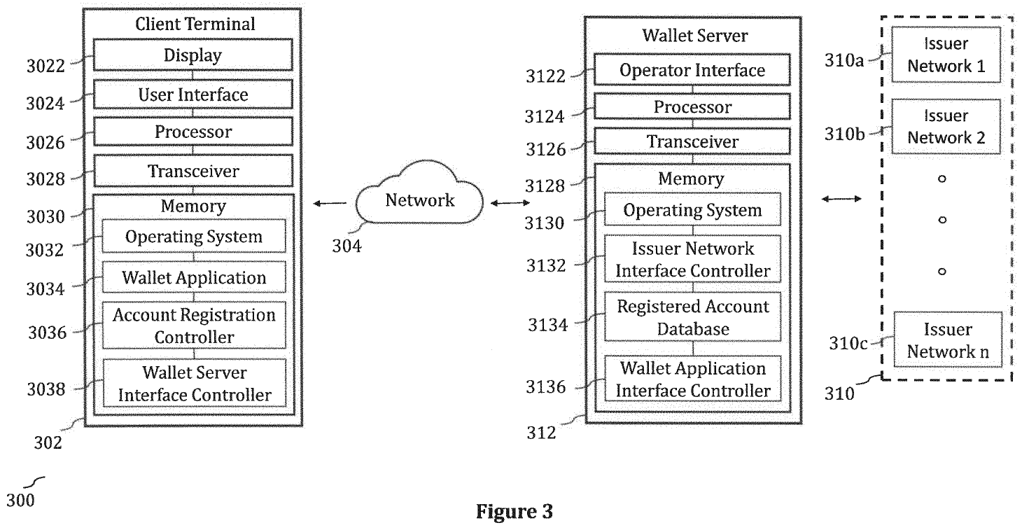

FIG. 3 illustrates a system environment 300 comprising client terminal 302, network 304, wallet server 312 and issuer network(s) 310.

Client terminal 302 may comprise any communication terminal configured for data processing operations and for network based communication. In specific embodiments, client terminal 302 may comprise a mobile communication device or a smartphone. Said client terminal 302 may include a display 3022, user interface 3024, processor 3026, communication transceiver 3028 and memory 3030, which memory 3030 may include transitory memory and/or non-transitory memory. In an exemplary embodiment, memory 3030 may have stored therewithin, (i) an operating system 3032 configured for managing device hardware and software resources and that provides common services for software programs implemented within client terminal 302, (ii) a wallet application 3034 configured to implement payment wallet functionality, (iii) an account registration controller 3036 configured to enable registration of a user's payment wallet with one more issuer networks for the purposes of enabling the payment wallet to retrieve information identifying available funds in one or more payment accounts that are maintained with the issuer network(s) and which payment accounts have been added to the payment wallet, and (iv) a wallet server interface controller 3038 configured to enable the payment wallet to query or pass instructions to wallet server 312.

Client terminal 302 may be communicably coupled with wallet server 312 through network 304. Wallet server 312 includes operator interface 3122, processor 3124, communication transceiver 3126 and memory 3128, which memory 3128 may include transitory memory and/or non-transitory memory. In an exemplary embodiment, memory 3128 may have stored therewithin, (i) an operating system 3130 configured for managing device hardware and software resources and that provides common services for software programs implemented within wallet server 312, (ii) an issuer network interface controller 3132 configured to enable wallet server 312 to interface and communicate with one or more issuer networks 310 (e.g. issuer network 1 (310a), issuer network 2 (310b) upto issuer network n (310c)), (iii) a registered account database 3134 configured to store records (i.e. wallet server data records that are discussed in more detail subsequently) that identify payment account(s) for which a wallet application 3034 is authorized to retrieve an available fund balance from a corresponding issuer network at which said payment account(s) is maintained, and (iv) a wallet application interface controller 3136 configured to enable wallet server 312 to interface and communicate with wallet application(s) 3034 implemented within client terminal(s) 302. It would be understood that wallet server 312 may be configured for communication with issuer networks 310a to 310c through any underlying communication network, including for example, network 304.

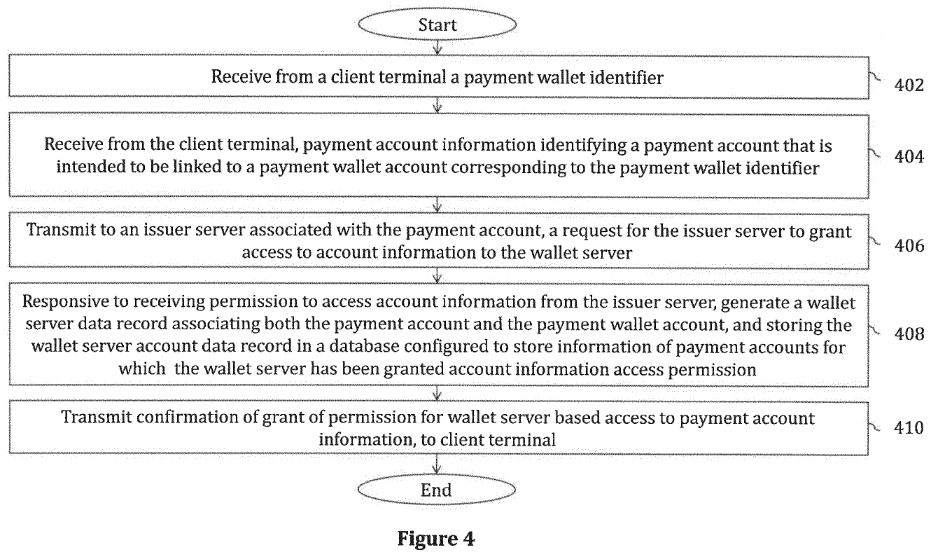

The operation of various components within system environment 300 would be discussed in more detail in connection with FIGS. 4 to 8 below.

FIG. 4 is a flowchart illustrating a method—as implemented at a wallet server 312—for registering permissions for a payment wallet to obtain available fund information corresponding to one or more payment accounts enrolled with said payment wallet. In an embodiment, wallet server 312 comprises a server configured to implement payment wallet functionality through a wallet application 3034 installed on client terminal 302.

The method of FIG. 4 commences at step 402, and comprises receiving from a client terminal 302, a payment wallet identifier that uniquely identifies a payment wallet account maintained by wallet server 312, or which identifies a unique instance of a wallet application associated with a payor/payment wallet account.

In various embodiments, the payment wallet identifier may comprise either a unique identifier associated with a payment wallet account maintained by wallet server 312, or may comprise a unique identifier associated with a unique instance of the wallet application installed on client terminal 302 and that is associated in turn with a payor/payment wallet account. In an embodiment, the payment wallet identifier may be transmitted from the client terminal 302 to wallet server 312. In a particular embodiment, the payment wallet identifier may be transmitted from account registration controller 3036 within the client terminal 302 to wallet application interface controller 3136 within wallet server 312.

Step 404 comprises receiving from client terminal 302, payment account information identifying a payment account (or a payment card or other payment vehicle) that is intended to be linked to a payment wallet account (or to an instance of a wallet application) corresponding to the received payment wallet identifier. In an embodiment, linking a payment account with a payment wallet account has the effect of enabling the payment wallet to be used for making payments through a the payment account that corresponds to the received payment account information. The payment account information received at step 404 may include one or more of a payment account identifier (or number) and optionally, information identifying an issuer institution or issuer network at which the payment account is maintained.

At step 406, wallet server 312 transmits to an issuer server associated with the payment account (e.g. an issuer server within any of issuer networks 310a to 310c), a request for said issuer server to grant to wallet server 312 (or to wallet application 3034 communicating through wallet server 312), permission to access account information (i.e. account information corresponding to the payment account). In an embodiment, the account information for which access rights are requested includes available fund information and/or available balance information and optionally, information identifying a minimum balance that requires to be maintained, corresponding to the payment account.

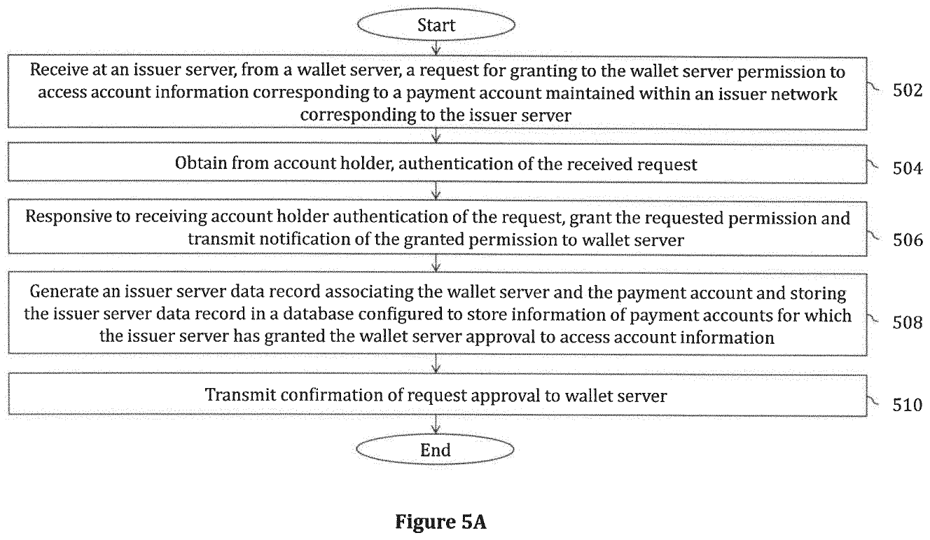

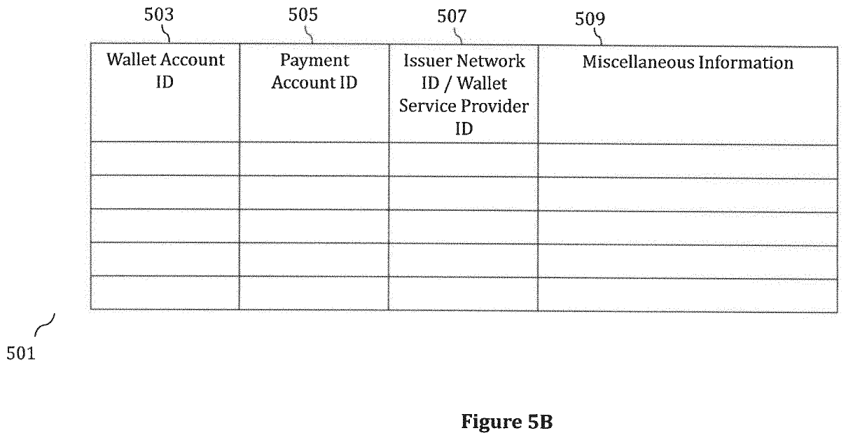

At step 408, responsive to receiving from the issuer server (within any of issuer networks 310a to 310c), permission granting wallet server 312 (or wallet application 3034 communicating through wallet server 312) access to account information corresponding to the payment account, wallet server 312 generates a wallet server data record—which wallet server data record associates the payment account and the payment wallet account with each other. The wallet server data record may in an embodiment be stored within registered account database 3134, which database is configured to store information of payment accounts for which the wallet server (or wallet application 3034 communicating through wallet server 312) has been granted account information access permission(s). FIG. 5B illustrates an exemplary data structure 501 of a type that can be used for generating the wallet server data record. For the purposes of generating a wallet server data record, data structure 501 may include (i) wallet account ID data field 503, configured to store a payment wallet identifier (for example, the payment wallet identifier received at step 402), (ii) a payment account ID data field 505, configured to store a payment account identifier (for example, information identifying the payment account, received at step 404), (iii) an issuer network ID data field 507, configured to store information identifying an issuer network at which the payment account is maintained, and (iv) a miscellaneous information data field 509, configured to store any miscellaneous information corresponding to a specific data record.

Step 410 comprises transmitting confirmation of grant of permission (i.e. grant of permission for wallet server 312 (or wallet application 3034 communicating through wallet server 312) to access payment account information from a corresponding issuer server) from wallet server 312 to client terminal 302. In a particular embodiment, the confirmation is transmitted from wallet application interface controller 3136 within wallet application server 312 to account registration controller 3036 within client terminal 302.

FIG. 5A is a flowchart illustrating a method—as implemented at an issuer server—for obtaining permissions for a payment wallet to obtain available fund information corresponding to one or more payment accounts enrolled with said payment wallet.

The method of FIG. 5A commences at step 502, and comprises receiving at an issuer server within issuer network 310a to 310c, from wallet server 312, a request for a request for granting to wallet server 312 (or to wallet application 3034 communicating through wallet server 312) permission to access account information corresponding to a payment account maintained within an issuer network corresponding to the issuer server.

Step 504 comprises obtaining from an account holder associated with the payment account, authentication of the request received at the issuer server. The authentication process of step 504 may be implemented according to any number of different authentication mechanisms that would be apparent to the skilled person, including without limitation through password, passcode, personal identification number (PIN) or one-time-password (OTP) or biometric based identity authentication.

At step 506, responsive to the issuer server receiving account holder authentication of the request for granting wallet server 312 (or wallet application 3034 communicating through wallet server 312) permission to access account information corresponding to the payment account, (i) the requested permission is granted by the issuer server and a (ii) notification of the granted permission is transmitted to wallet server 312 (or to wallet application 3034 communicating through wallet server 312).

Step 508 thereafter comprises generating at the issuer server (within issuer network 310a to 310c), an issuer server data record associating the wallet server 312 and the payment account, and storing the issuer server data record in a database configured to store information of payment accounts for which the issuer server has granted the wallet server 312 (or a wallet application 3034 communicating through wallet server 312) approval to access account information. In an embodiment, the issuer server data record is stored in a database within the issuer network (i.e. within any of issuer networks 310a to 310c) to which the issuer server corresponds.

FIG. 5B illustrates an exemplary data structure 501 of a type that can be used for generating the wallet server data record. For the purposes of generating a wallet server data record, data structure 501 may include (i) wallet account ID data field 503, configured to store a payment wallet identifier (for example, the payment wallet identifier received at step 402), (ii) a payment account ID data field 505, configured to store a payment account identifier (for example, information identifying the payment account, received at step 404), (iii) a wallet service provider ID data field 507, configured to store information identifying a wallet server provider or a wallet server 312 corresponding to the identified payment wallet, and (iv) a miscellaneous information data field 509, configured to store any miscellaneous information corresponding to a specific data record.

Step 510 comprises transmitting confirmation of grant of permission (for wallet server 312 or wallet application 3034 to access payment account information from the issuer server) to one or both of wallet server 312 and client terminal 302. In a particular embodiment, the confirmation is transmitted from the issuer server to issuer network interface controller 3132 within wallet server 312. In another embodiment, the confirmation is transmitted from the issuer server to wallet application 3034 in client terminal 302.

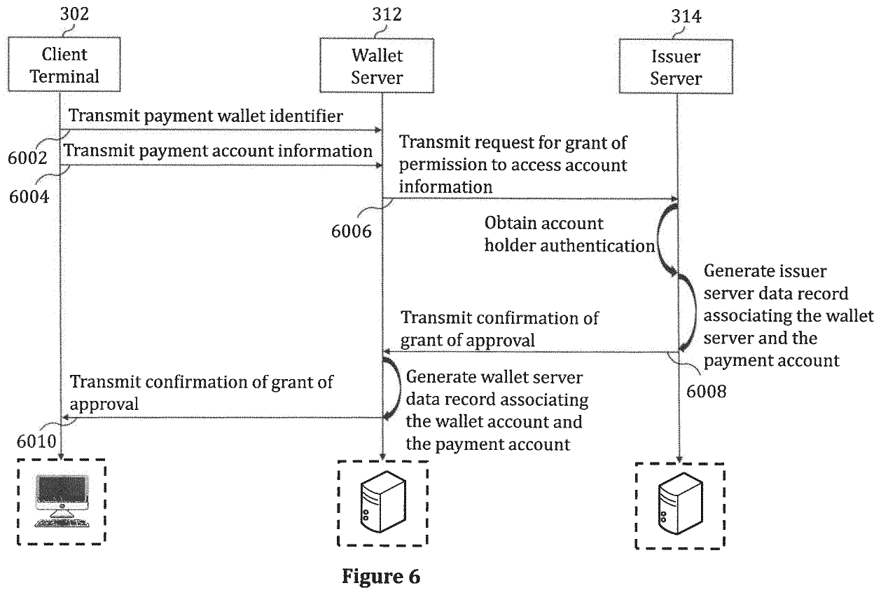

FIG. 6 is a communication flow diagram illustrating a communication flow between system entities in implementing methods for obtaining permissions for a wallet server to access account information corresponding to a payment account linked to a payment wallet account (which methods have been previously described in connection with FIGS. 4 and 5 above).

Step 6002 comprises transmitting from client terminal 302 to wallet server 312, a payment wallet identifier. The payment wallet identifier may comprise either a unique identifier associated with an instance of a wallet application 3034 installed on client terminal 302, or may comprise a unique identifier associated with a payment wallet account maintained at wallet server 312.

Step 6004 comprises transmitting from client terminal 302 to wallet server 312, payment account information. The payment account information identifies a payment account (or a payment card or other payment vehicle) that is intended to be linked to a payment wallet account (or to an instance of a wallet application) corresponding to the payment wallet identifier transmitted at step 6002. The payment account information transmitted at step 6004 may include one or more of a payment account identifier (or number) and information identifying an issuer institution or issuer network at which the payment account is maintained.

At step 6006, wallet server 312 transmits to issuer server 314, a request for issuer server 314 to grant wallet server 312 (or wallet application 3034 communicating through wallet server 312) permission to access account information (i.e. account information corresponding to the payment account identified at step 6002). In an embodiment, the account information for which access rights are requested includes available fund information or available balance information and optionally minimum balance information corresponding to the payment account.

Responsive to receiving the request transmitted at step 6006, issuer server 310 obtains from an account holder, authentication of the request for grant of permission for wallet server 312 (or wallet application 3034 communicating through wallet server 312) to access to account information (i.e. account information corresponding to the payment account). Subject to obtaining authentication of the request from the account holder, issuer server 310 generates an issuer server data record associating the wallet server and the payment account, and storing the issuer server data record in a database configured to store information of payment accounts for which the issuer server has granted the wallet server (or wallet application 3034 communicating through wallet server 312) approval to access account information.

Step 6008 comprises transmitting from issuer server 310 to wallet server 312 confirmation of grant of the requested permission by issuer server 310. Upon receipt of said confirmation, wallet server 312 may generate and store a wallet server data record, which wallet server data record associates the payment account and the payment wallet account with each other. The wallet server data record may in an embodiment be stored within a database configured to store information of payment accounts for which the wallet server has been granted account information access permission(s).

Step 6010 thereafter comprises transmitting from wallet server 312 to client terminal 302, confirmation of grant of the requested permission by issuer server 310—which confirmation may be displayed to a user on display 3022 of client terminal 302, or through user interface 3024 of client terminal 302.

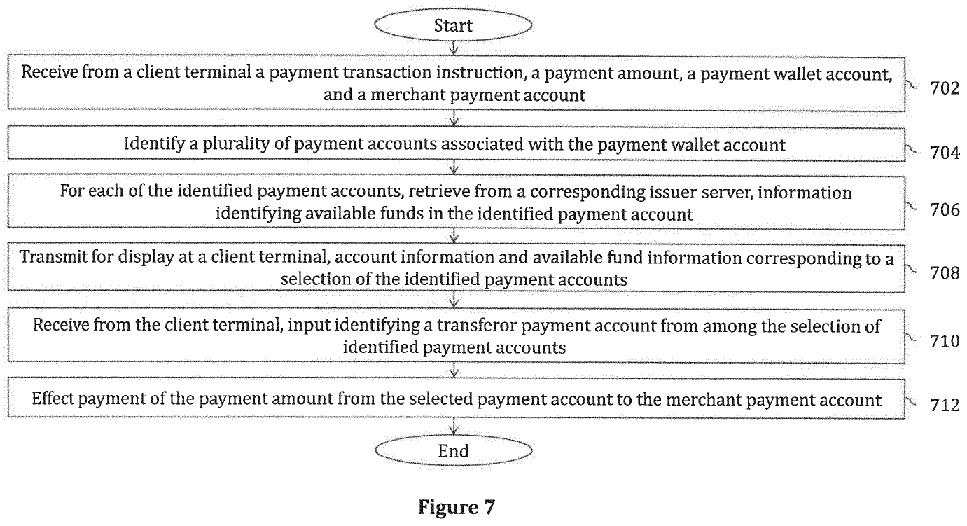

FIG. 7 is a flowchart illustrating a method for effecting an electronic payment in accordance with the present invention. Implementation of the method of FIG. 7 is made possible when a wallet server has obtained permissions to query and receive (from issuer server(s) associated with payment accounts linked to a payment wallet account maintained with the wallet server) payment account information corresponding to one or more payment accounts linked to the payment wallet account—for example in accordance with the descriptions that have been provided in connection with FIGS. 4 to 6 above. In an embodiment, the method of FIG. 7 may be implemented at wallet server 312.

At step 702, wallet server 312 receives from a client terminal 302, a payment transaction instruction accompanied by information identifying a payment amount, a payment wallet account (i.e. a payment wallet account associated with an instance of a payment wallet installed on client terminal 302, and which is being used for implementing the payment transaction) and a merchant payment account to which the payment amount requires to be transferred. In an embodiment of the method, the payment instruction and accompanying information may be transmitted to wallet application interface controller 3136 (within wallet server 312), from wallet server interface controller 3038 (within client terminal 302).

Step 704 comprises identification by wallet server 312 of a plurality of payment accounts associated with the identified payment wallet account. In an embodiment, information identifying the payment accounts associated with the payment wallet account may be retrieved from one or more wallet server data records that associate the identified payment wallet account with one or more payment accounts. In an embodiment, the wallet server data records may be retrieved from registered account database 3134 within wallet server 312. Based on the discussion in connection with FIGS. 4 and 5, it would be understood that the payment accounts that are identified based on data retrieved from wallet server data record(s) may in an embodiment comprise payment accounts for which the wallet server 312 (or wallet application 3034 communicating through wallet server 312) has been granted account information access permission(s), including permission to access at least available balance or available fund information corresponding to such payment accounts.

At step 706, for each of the payment accounts identified at step 704, wallet server 312 retrieves from a corresponding issuer server (i.e. an issuer server within an issuer network with which the payment account is maintained), information identifying available funds or an available fund balance and optionally a minimum balance requirement, associated with the identified payment account. In one embodiment, this information is retrieved by issuer network interface controller 3132 querying the relevant issuer server.

At step 708, account information (for example, an account number, and corresponding issuer network information) and information identifying available funds or an available fund balance (and optionally a required minimum balance), associated with each of the payment accounts identified at step 704 is transmitted to client terminal 302 for display. In an embodiment, the account information and available fund information is transmitted to wallet application 3034 and is thereafter displayed at display 3022 of client terminal 302. In a particular embodiment, display of account information and available fund information at step 708 may be preceded by a filtering step—which filtering step applies one or more predefined rules to select a sub-set of payment accounts that are associated with the payment account wallet, and wherein account information and available fund information corresponding only to such sub-set of payment accounts may be displayed at client terminal 302. In a specific embodiment of the invention, at step 708, the pre-defined rules may require that display of account information and available fund information at client terminal 302 is restricted to only such payment accounts (i) where the available funds in said payment account(s) is greater than the payment amount corresponding to the payment transaction (which payment amount has been received at step 702) or (ii) where a difference between the available funds in said payment account(s) and a minimum fund balance required to be maintained in the payment account(s), is greater than the payment amount corresponding to the payment transaction (which payment amount has been received at step 702). In other words, the display of payment accounts available for implementing the payment transaction is restricted to payment accounts that have sufficient liquid funds to effect the requested payment transaction.

At step 710, wallet server 312 receives from client terminal 302, user input selecting one of the displayed payment accounts for implementation of the payment transaction. In an embodiment, the user input is received through user interface 3024 and is communicated to wallet application 3034—from where said input is transmitted to wallet server 312 by way of network communication established between wallet server interface controller 3038 (in client terminal 302) and wallet application interface controller 3136 (in wallet server 312). In an embodiment, (i) a firts user input selecting one of the displayed payment accounts for implementation of the payment transaction may be rejected (and a second user input may be invited for selecting another payment account) or (ii) a second user input confirming the earlier selection indicated by the first user input—may be invited in a case (a) where the available funds in payment account selected by the first user input is less than the payment amount corresponding to the payment transaction (which payment amount has been received at step 702) or (b) where a difference between the available funds in said payment account and a minimum fund balance required to be maintained in the payment account, is less than the payment amount corresponding to the payment transaction (which payment amount has been received at step 702). In other words, selection of payment accounts available for implementing the payment transaction may be rejected or may only be permitted after seeking a second confirmatory input, in case a payment account does not have sufficient available funds/sufficient liquid funds to effect the requested payment transaction.

Step 712 comprises effecting through wallet server 312, payment of the payment amount (received at step 702) from the selected payment account (selected based on user input at step 710) to the merchant payment account (identified at step 702). In an embodiment, effecting payment through wallet server 312 comprises transmitting to an issuer network associated with the selected payment account, a request for initiation of electronic payment of the payment amount from the selected payment account to the merchant payment account. The issuer network responds by debiting the payment amount from the selected payment account and crediting it to the merchant payment account.

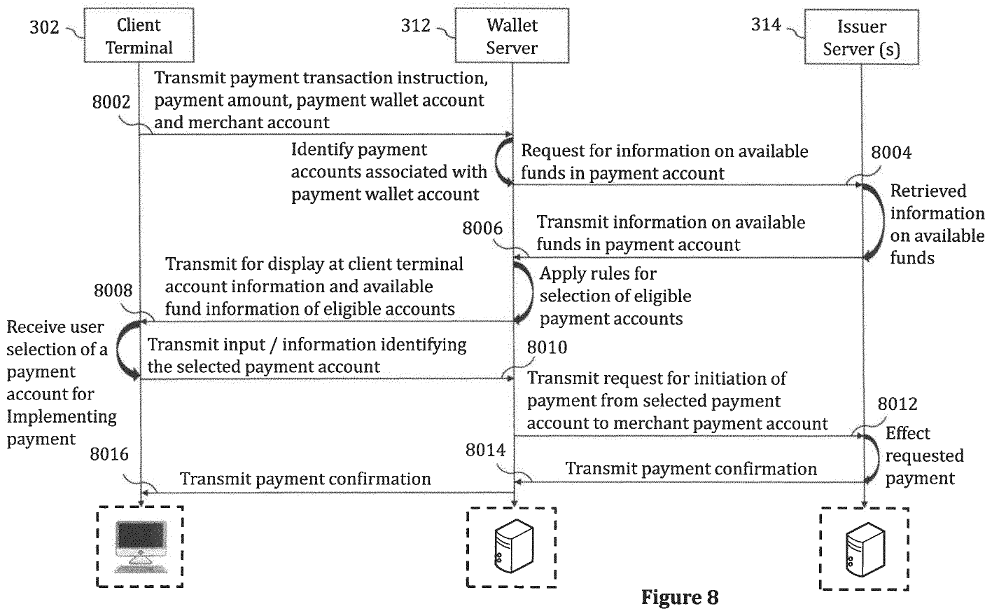

FIG. 8 is a communication flow diagram illustrating communication flow between system entities in implementing a method (for example, the method of FIG. 7) for effecting an electronic payment in accordance with the present invention.

At step 8002, client terminal 302 transmits to wallet server 312, a payment transaction instruction accompanied by information identifying a payment amount, a payment wallet account (i.e. a payment wallet account associated with an instance of a wallet application 3034 installed on client terminal 302, and which is being used for implementing the payment transaction) and a merchant payment account to which the payment amount requires to be transferred.

Wallet server 312 identifies payment accounts associated with the identified payment wallet account. In an embodiment, information identifying payment accounts associated with the payment wallet account may be retrieved from one or more wallet server data records that associate the identified payment wallet account with one or more payment accounts. For the purposes of the invention, the payment accounts that are identified based on data retrieved from wallet server data record(s) are payment accounts for which the wallet server has been granted account information access permission(s), including permission to access at least available balance or available fund information corresponding to such payment accounts.

At step 8004, for each of the payment accounts identified by wallet server 312, wallet server 312 transmits to a corresponding issuer server 314, a request for information regarding available funds in the payment account. Issuer server 314 responds to the request by retrieving information regarding available funds in said payment account, which information is transmitted back to wallet server 312 at step 8006 and optionally, onward to wallet application 3034 in client terminal 302.

Wallet server 312 thereafter optionally applies one or more predefined rules for selecting a sub-set of payment accounts that are eligible for display on client terminal 302 for the purpose of selection of a payment account for effecting the payment transaction. In an embodiment, the one or more predefined rules for selecting a sub-set of payment accounts that are eligible for display on client terminal 302 may be applied at the client terminal 302 instead of at wallet server 312. Exemplary predefined rules may include one or more rules that result in selection of (i) a sub-set of payment accounts that are associated with the payment account wallet, wherein the available funds in each payment account within the sub-set is greater than the payment amount corresponding to the payment transaction (which payment amount has been received at step 8002) or (ii) a sub-set of payment accounts that are associated with the payment account wallet and where a difference between the available funds in each payment account in the sub-set and a corresponding minimum fund balance required to be maintained in such payment account, is greater than the payment amount corresponding to the payment transaction (which payment amount has been received at step 8002).

Step 8008 comprises transmitting for display at client terminal 302, account information and available fund information corresponding to (i) the payment accounts identified based on the information received at wallet server 312 at step 8006, or (ii) payment accounts within a sub-set of payment accounts that have been filtered or selected based on one or more predefined rules for selecting a sub-set of payment accounts that are eligible for display on client terminal 302.

Client terminal 302 displays the account information and available fund information received from wallet server 312—and receives through a user interface, one or more user inputs selecting a payment account from among the displayed payment accounts for implementing the payment transaction. At step 8010 the received input or information identifying the selected payment account is transmitted from client terminal 302 to wallet server 312.

Wallet server 312 thereafter transmits to an issuer server 314 associated with the selected payment account, a request for initiation of electronic payment of the payment amount (identified at step 8002) from the selected payment account (selected based on user input received at client terminal 302) to the merchant payment account (identified at step 8002). In an embodiment, the issuer network responds by debiting the payment amount from the selected payment account and crediting it to the merchant payment account.

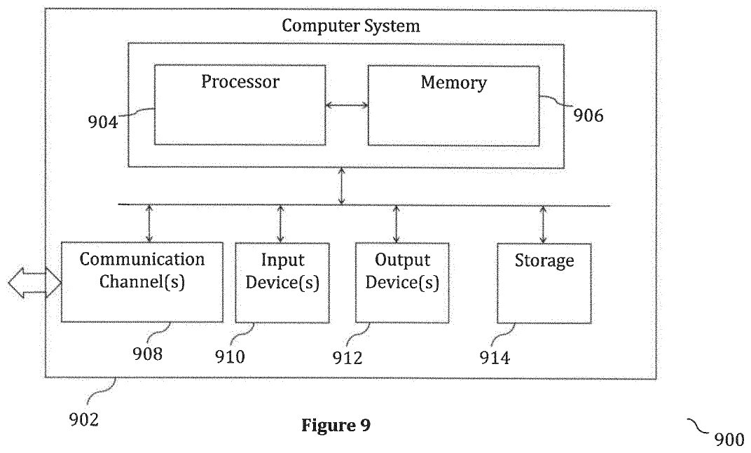

FIG. 9 illustrates an exemplary computer system according to which various embodiments of the present invention may be implemented.

System 900 includes computer system 902 which in turn comprises one or more processors 904 and at least one memory 906. Processor 904 is configured to execute program instructions—and may be a real processor or a virtual processor. It will be understood that computer system 902 does not suggest any limitation as to scope of use or functionality of described embodiments. The computer system 902 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 902 in accordance with the present invention may include one or more servers, desktops, laptops, tablets, smart phones, mobile phones, mobile communication devices, tablets, phablets and personal digital assistants. In an embodiment of the present invention, the memory 906 may store software for implementing various embodiments of the present invention. The computer system 902 may have additional components. For example, the computer system 902 may include one or more communication channels 908, one or more input devices 910, one or more output devices 99, and storage 914. An interconnection mechanism (not shown) such as a bus, controller, or network, interconnects the components of the computer system 902. In various embodiments of the present invention, operating system software (not shown) provides an operating environment for various softwares executing in the computer system 902 using a processor 904, and manages different functionalities of the components of the computer system 902.

The communication channel(s) 908 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 910 may include, but is not limited to, a touch screen, a keyboard, mouse, pen, joystick, trackball, a voice device, a scanning device, or any another device that is capable of providing input to the computer system 902. In an embodiment of the present invention, the input device(s) 910 may be a sound card or similar device that accepts audio input in analog or digital form. The output device(s) 99 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 902.

The storage 914 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 902. In various embodiments of the present invention, the storage 914 may contain program instructions for implementing any of the described embodiments.

In an embodiment of the present invention, the computer system 902 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 902. The method described herein is typically implemented as a computer program product, comprising a set of program instructions that is executed by the computer system 902 or any other similar device. The set of program instructions may be a series of computer readable codes stored on a tangible medium, such as a computer readable storage medium (storage 914), for example, diskette, CD-ROM, ROM, flash drives or hard disk, or transmittable to the computer system 902, via a modem or other interface device, over either a tangible medium, including but not limited to optical or analogue communications channel(s) 908. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be apparent that the present invention offers significant advantages—in particular, by displaying to a user the available balance(s) associated with each payment account that is linked to a payment wallet, and by reducing the likelihood of a user erroneously selecting for payment, a payment account that has insufficient funds for effecting a payment transaction. Implementation of this approach results in a significantly lower number of situations where an account holder is penalized for initiating a payment transaction based on a payment account having low or insufficient funds, and also improves the overall user experience by reducing the total number of transaction failures that may occur due to insufficiency of funds.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

1. A system for implementing a payment wallet based electronic payment transaction, the system comprising, a processor implemented wallet server configured to:
receive from a wallet application installed on a client terminal, (i) a payment amount, (ii) a payment wallet account associated with a payor and (iii) a payee account;
identify a plurality of payment accounts associated with the identified payment wallet account;
for each identified payment account, retrieve from a corresponding issuer server, information identifying available funds in said payment account;
transmit account information corresponding to one or more of the identified payment accounts to the client terminal;
receive from the client terminal, input identifying a selected payment account from among the identified payment accounts; and
transmit to an issuer network associated with the selected payment account, a payment initiation request for effecting payment of the payment amount from the selected payment account to the payee account.

2. The system as claimed in claim 1, wherein the wallet server is configured such that, for each of the plurality of payment accounts associated with the identified payment wallet account, the wallet server has been allowed permission to access from each corresponding issuer network, available balance information corresponding to the payment account.

3. The system as claimed in claim 1, wherein the wallet server is additionally configured to retrieve for each identified payment account, information identifying a minimum balance requirement associated with said payment account.

4. The system as claimed in claim 1, wherein the wallet server is configured such that the transmitted account information corresponding to one or more of the identified payment accounts comprises at least an account number and information representing available funds corresponding to said one or more of the identified payment accounts.

5. The system as claimed in claim 1, wherein at least one or the wallet server and the client terminal is configured to enable the client terminal to display a selected subset of said one or more of the identified payment accounts, wherein (i) each of the payment accounts within the selected subset has available funds greater than the payment amount, or (ii) for each of the payment accounts within the selected subset, a difference between the available funds and a required minimum balance associated with such payment account is greater than the payment amount.

6. The system as claimed in claim 5, wherein the selected payment account is selected from among the selected subset.

7. The system as claimed in claim 5, wherein the selected payment account is selected from among the select subset based on user input received at the client terminal.

8. The system as claimed in claim 1, wherein the issuer network responds to receiving the payment initiation request by debiting the payment amount from the selected payment account and crediting the payment amount to the payee account.

9. A method for implementing a payment wallet based electronic payment transaction, the method comprising, at a wallet server:
receiving from a wallet application installed on a client terminal, (i) a payment amount, (ii) a payment wallet account associated with a payor and (iii) a payee account;
identifying a plurality of payment accounts associated with the identified payment wallet account;
for each identified payment account, retrieving from a corresponding issuer server, information identifying available funds in said payment account;
transmitting account information corresponding to one or more of the identified payment accounts to the client terminal;
receiving from the client terminal, input identifying a selected payment account from among the identified payment accounts; and
transmitting to an issuer network associated with the selected payment account, a payment initiation request for effecting payment of the payment amount from the selected payment account to the payee account.

10. The method as claimed in claim 9, wherein for each of the plurality of payment accounts associated with the identified payment wallet account, the wallet server has been allowed permission to access from each corresponding issuer network, available balance information corresponding to the payment account.

11. The method as claimed in claim 9, comprises additionally retrieving for each identified payment account, information identifying a minimum balance requirement associated with said payment account.

12. The method as claimed in claim 9, wherein the transmitted account information corresponding to one or more of the identified payment accounts comprises at least an account number and information representing available funds corresponding to said one or more of the identified payment accounts.

13. The method as claimed in claim 9, comprising displaying at the client terminal a selected subset of said one or more of the identified payment accounts, wherein (i) each of the payment accounts within the selected subset has available funds greater than the payment amount, or (ii) for each of the payment accounts within the selected subset, a difference between the available funds and a required minimum balance associated with such payment account is greater than the payment amount.

14. The method as claimed in claim 13, wherein the selected payment account is selected from among the selected subset.

15. The method as claimed in claim 13, wherein the selected payment account is selected from among the select subset based on user input received at the client terminal.

16. The method as claimed in claim 9, wherein the issuer network responds to receiving the payment initiation request by debiting the payment amount from the selected payment account and crediting the payment amount to the payee account.

17. A computer program product configured for implementing a payment wallet based electronic payment transaction, the computer program product comprising a non-transitory computer readable medium having a computer readable program code embodiment therein, said computer readable program code comprising instructions for implementing at a wallet server:
receiving from a wallet application installed on a client terminal, (i) a payment amount, (ii) a payment wallet account associated with a payor and (iii) a payee account;
identifying a plurality of payment accounts associated with the identified payment wallet account;
for each identified payment account, retrieving from a corresponding issuer server, information identifying available funds in said payment account;
transmitting account information corresponding to one or more of the identified payment accounts to the client terminal;
receiving from the client terminal, input identifying a selected payment account from among the identified payment accounts; and
transmitting to an issuer network associated with the selected payment account, a payment initiation request for effecting payment of the payment amount from the selected payment account to the payee account.
